(19) United States
(12) Patent Application Publication
(10) Pub. No.: US 2025/0148901 A1
(43) Pub. Date: May 8, 2025

(54) SMART DEVICE BURN DETECTOR

(71) Applicant: David Boyden, Cassopolis, MI (US)

(72) Inventor: David Boyden, Cassopolis, MI (US)

(21) Appl. No.: 18/987,390

(22) Filed: Dec. 19, 2024

Related U.S. Application Data
(63) Continuation-in-part of application No. 17/669,259, filed on Feb. 10, 2022.

(51) Int. Cl. G08B 25/10; G08B 21/02

(52) U.S. Cl. CPC G08B 25/10; G08B 21/02

(57) ABSTRACT

A detector may include a male electrical connector, an electrical detection circuit, and a wireless transmitter. The electrical detection circuit receives power through the male electrical connector; detects a predetermined hazard, the predetermined hazard including a gaseous hazard, a thermal hazard, or both a gaseous hazard and a thermal hazard; and upon detection of the predetermined hazard, generates an electrical signal indicating that the predetermined hazard has been detected. The wireless transmitter receives power through the male electrical connector and, upon receiving the electrical signal, transmits a wireless signal indicating that the predetermined hazard has been detected. The detector may be used in a system including a plurality of such detectors plugged into a plurality of electrical sockets in an electrical circuit in a structure. In use, the detector(s), upon detecting the predetermined hazard, wirelessly alert a monitoring unit that then wirelessly transmits a warning signal.

### CROSS REFERENCE TO RELATED APPLICATIONS

This application is a continuation-in-part of U.S. Utility patent application Ser. No. 17/669,259 filed Feb. 10, 2022, now pending.

### BACKGROUND

It has been well known and documented (National Fire Protection Association} that electrical fires are known to burn for up to seven hours, before ignition. Frequently, faulty wiring will generate heat for a long time before an ignition temperature is reached. Circuit breakers, ground fault circuit interrupters (“GFCI”), and smart circuit breakers do not catch these heating situations fast enough, or many times, not at all. It would be desirable, therefore, to provide a method of detecting those heating situations in a manner to allow people to be saved from electrical fires or even carbon dioxide poison.

### SUMMARY

In some embodiments disclosed herein, a detector comprises a male electrical connector, an electrical detection circuit, and a wireless transmitter. The electrical detection circuit receives power through the male electrical connector; detects a predetermined hazard, the predetermined hazard including a gaseous hazard, a thermal hazard, or both a gaseous hazard and a thermal hazard; and upon detection of the predetermined hazard, generates an electrical signal indicating that the predetermined hazard has been detected. The wireless transmitter receives power through the male electrical connector and, upon receiving the electrical signal, transmits a wireless signal indicating that the predetermined hazard has been detected.

In other embodiments, a system, comprises a structure; an electrical circuit in the structure, the electrical circuit including an electrical socket; a detector disposed within the structure and plugged into the electrical socket to detect a predetermined hazard; and a monitoring unit. The type of detected predetermined hazard includes a gaseous hazard, a thermal hazard, or both a gaseous hazard and a thermal hazard. The detector includes: an electrical detection circuit detecting the predetermined hazard and generating an electrical signal indicating that the predetermined hazard has been detected; and a wireless transmitter that, upon receiving the electrical signal, transmits a wireless signal indicating that the predetermined hazard has been detected. The monitoring unit may be in wireless communication with the detector that, upon receiving the wireless signal, wirelessly transmits a warning signal to a client device.

In still other embodiments, a method comprises plugging a detector into an electrical socket in an electrical circuit in a structure; upon the detector detecting a predetermined hazard, generating from the detector a wireless signal indicating that the predetermined hazard has been detected, the predetermined hazard includes a gaseous hazard, a thermal hazard, or both a gaseous hazard and a thermal hazard; transmitting the wireless signal from the detector; wirelessly monitoring a location of the structure; detecting the wireless signal indicating that the predetermined hazard has been detected; and wirelessly transmitting a warning signal to a client device.

The above presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

### BRIEF DESCRIPTION OF THE DRAWINGS

Illustrative embodiments of the subject matter claimed below will now be disclosed. In the interest of clarity, not all features of an actual implementation are described for every example in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

FIG. 1 conceptually depicts system for a detector in accordance with one or more embodiments.

FIG. 2 schematically depicts one particular implementation of the monitoring unit in FIG. 1.

FIG. 3A-FIG. 3C illustrate one particular implementation of the detector first shown in FIG. 1.

FIG. 4 conceptually depicts a system for a detector in accordance with one or more embodiments.

FIG. 5A-FIG. 5B illustrate one particular implementation of the electrical detection circuit shown in FIG. 3 of the detector first shown in FIG. 1.

FIG. 6 is, more particularly, a detail of selected portions of FIG. 5A.

FIG. 7 depicts a predetermined hazard such as may be detected using the method and apparatus disclosed herein.

FIG. 8 is an exemplary user interface display unit for setting up communication with the central processing unit.

FIG. 9 shows a plurality of detectors and user devices being configured for the operation of the hazard detection and notification system provided herein.

FIG. 10 is an exemplary user interface for displaying the emergency response locations, user data, and user location.

FIG. 11 is an exemplary user interface display for user communication with the central processing unit.

FIG. 12 is an exemplary user interface display for enabling user selection of a predetermined hazard.

FIG. 13 is an exemplary user interface display for the selection of an emergency response location.

FIG. 14 is a flow chart showing the preferred embodiment of the hazard detection and notification system provided herein.

While the invention is susceptible to various modifications and alternative forms, the drawings illustrate specific examples herein described in detail by way of example. It should be understood, however, that the description herein of specific examples is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

One or more specific embodiments of the present invention will be described below. The present invention is not limited to the embodiments and illustrations contained herein, but include modified forms of those embodiments including portions of the embodiments and combinations of elements of different embodiments as come within the scope of the appended claims. In the development of any such actual implementation, as in any engineering or design project, numerous implementation-specific decisions must be made to achieve the developers' specific goals, such as compliance with system-related and business-related constraints, which may vary from one implementation to another. Moreover, such a development effort might be complex and time consuming, but would nevertheless be a routine undertaking of design, fabrication, and manufacture for those of ordinary skill having the benefit of this disclosure.

This system or modules disclosed herein are, in general, used to detect electrical fires and/or carbon dioxide poison. In addition, a smoke detector may also be incorporated as a component. These modules are not meant to replace any current market devices. Instead, disclosed devices are intended to be an enhancement or augmentation for devices used in the alarm industry and save lives. The modules are designed for individual, residence, and business establishments. The ease of installation makes these systems very practical for many different end uses.

As mentioned above, the disclosed system provides an ease of installation which, in one example, module installation is performed by removing the outlet plate screw on an electrical plug so the plate may be lifted off, plugging the module in and then replacing the outlet plate screw with the module in place. After physical installation, a smart device (e.g., phone, tablet, laptop, etc.) may execute an application for identification of the module (e.g., Proventor—Z, account # A12483). Next the user may program the module using prompts displayed in the application. The modules may provide a sensor for each junction box in the building to be guarded. For example, the residence may be monitored and a display (smart device) may be used to provide indications showing the outlets that are heated above the point of distress. The reporting side, being a display (smart device), may also provide the user with the location, floor number, and account number of users. The module may include a wireless communication device that operates, for example, at a frequency of 2.4 Giga Hertz range. The alarm system may be used for detecting electrical fires, carbon dioxide, and smoke (either alone or in any combination thereof).

As mentioned above, the apparatus is extremely simple in its installation. It is recommended to install at least one module in each room of the establishment (e.g., structure being monitored). The master module may then communicate with the modules to which it is connected. The master module light (the name of the controlling main module) may further separate communications from the different apartment units to account for possible (and undesirable) cross talk.

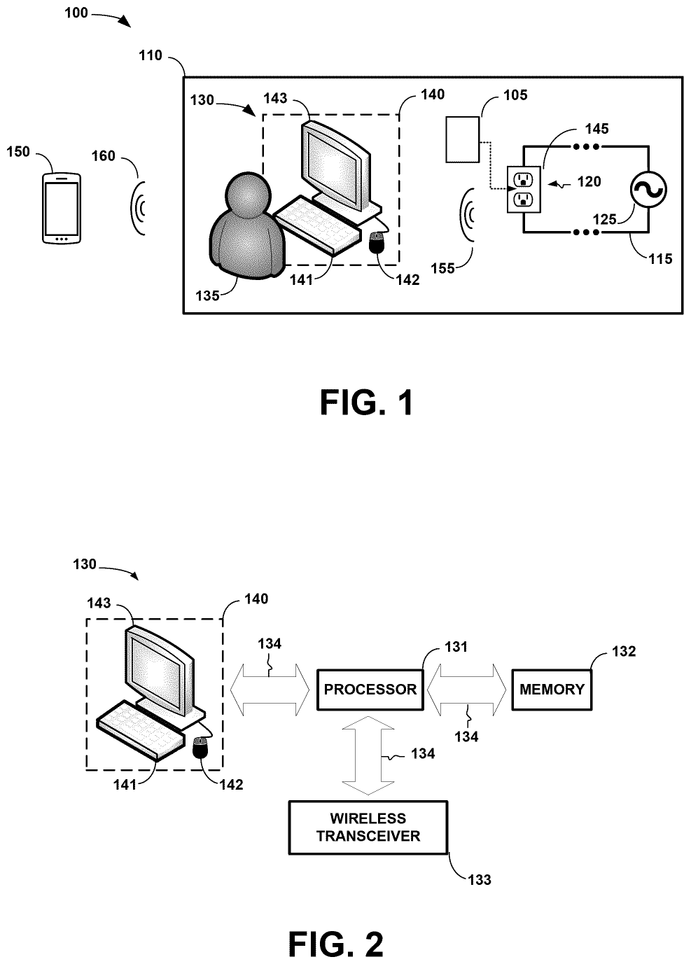

Turning now to the drawings, FIG. 1 conceptually depicts a system 100 for a detector 105 in accordance with one or more embodiments. The system 100 includes a structure 110 in which an electrical circuit 115 is disposed. The structure 110 may be a habitable structure or may be a structure that is not intended for human habitation. The electrical circuit 115 includes at least one socket 120, and typically includes a plurality of such sockets 120. The electrical circuit 115 receives power from a power source 125. The detector 105 is in wireless communication with a monitoring unit 130.

The electrical power source 125 will typically be receiving power from an electrical grid (e.g., a power distribution system that provides power to houses within a geographical area) with the electrical power being received through a braker panel at each house (e.g., structure 110). However, almost any power source may be used. In other embodiments, the power source 125 may alternatively be, for example and without limitation, an alternating current (“AC”) generator or a direct current (“DC”) generator providing power through an inverter. “Green” technologies, such as solar panels or heat pumps, may also be used in still other embodiments. Although the electrical power in the illustrated embodiment is AC power, some embodiments may use DC power. In some cases, multiple power sources may be concurrently or alternatively used to provide power (e.g., a backup generator that only provides power when grid power is not available).

In the example of FIG. 1, the monitoring unit 130 is a computing apparatus running under the control of a programmed processor-based resource. As used herein, the term “processor-based resource” may be, without limitation, a processor, a processor chipset, or a collection of processors allocated from, for example, a cloud or other group of computing resources. As will be appreciated by those in the art having the benefit of this disclosure, a processor chipset may include several different kinds of processors designed to be used together, such as a microprocessor and a co-processor. Similarly, a processor-based resource allocated from a cloud may include several, or even many, processors, including processors of different types.

A “processor”, as is well known and understood in the art, may be any kind of programmed integrated circuit executing programmed instructions to impart a functionality thereto. For example, a processor may be a microcontroller, a controller, a microprocessor, a digital signal processor (“DSP”), or a co-processor (e.g., a graphics co-processor or a math co-processor). A processor may also be an application specific integrated circuit (“ASIC”), erasable programmable read only memory, (“EPROM”), or electrically erasable programmable read only memory (“EEPROM”). These examples are neither exclusive nor exhaustive. Those in the art having the benefit of this disclosure may realize still other implementations for a processor.

In the embodiment of FIG. 1, the monitoring unit 130 may be a personal computer of some kind such as a laptop or a desktop computer. However, alternative embodiments may use other kinds computing devices, such as a wireless router or a modem. One such embodiment is discussed below. However, implementing the monitoring unit 130 as a personal computer has the advantage of providing an interface for the user 135 to interact with the system 100 more easily. The interface for the user is commonly referred to as a “user interface” (“UI”) 140.

However, in other embodiments, the monitoring unit may be a fire panel, a smart television (“TV”), or some other smart apparatus. A fire panel is a communication apparatus found in some commercial and multi-unit residential structures that is hardwired to the local fire department to notify the fire department of a fire or other hazard. Thus, in such embodiments, the warning signal may be transmitted from the monitoring unit (i.e., the fire panel) over a wired connection to a client device located at the local fire department.

User 135 may use user interface 140 to interact with the system 100. The user interface 140 may include, for instance, peripheral input devices such as a keyboard 141, a pointing device (or “mouse”) 142, and a display 143. The user 135 may view messages, locations of detected hazards, and such through the user interface 140. Upon notification, user 135 may also take actions such as notifying emergency services in embodiments including such a user interface. It is also possible that emergency services notifications are provided automatically by the disclosed system (i.e., without involvement of user 135).

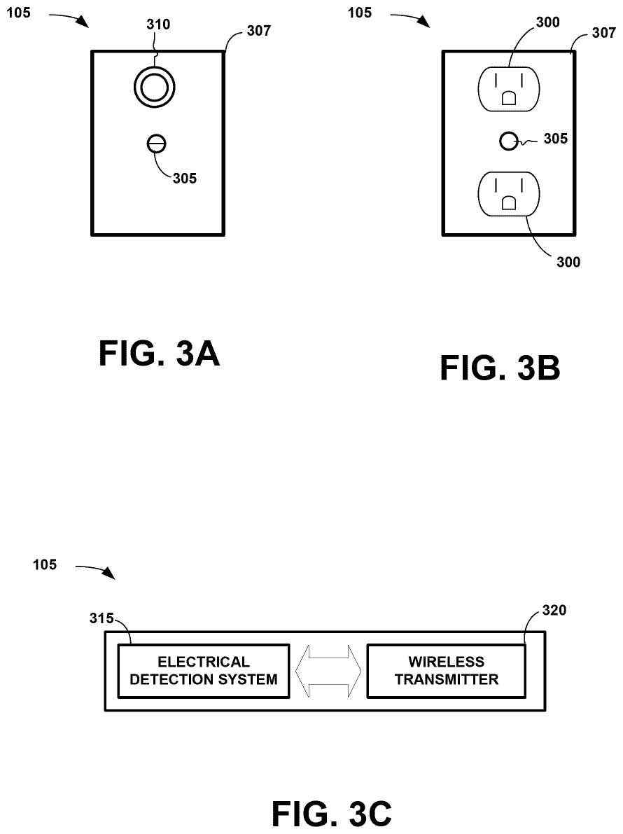

FIG. 2 schematically depicts one particular implementation of the monitoring unit 130 in FIG. 1. The monitoring unit 130 includes, in this particular embodiment, a central processing unit 131, a memory 132, and a wireless transceiver 133, all of which communicate with one another over a communications bus 134. The central processing unit 131 runs under the programmed control provided by executing instructions (not otherwise shown) residing in the memory 132. This may include instructions for presenting an interface such as a graphical user interface (“GUI”) to the user 135. The wireless transceiver 133 transmits and receives wireless signals at the direction of the central processing unit 131. As mentioned above, the monitoring unit 130 is in wireless communication with the detector 105 and, upon receiving a wireless signal from the detector 105, wirelessly transmits a warning signal to a client device 150 (shown in FIG. 1).

In the illustrated embodiments, the client device 150 includes a processor-based resource and is programmed to receive the warning signal 160, extract encoded information, and then communicate the encoded information to the user (not shown) of the client device 150. As will be discussed below, the encoded information may include a location identifier and/or a hazard identifier. The client device 150 therefore, in these particular embodiments, communicate the location and nature of the detected hazard. The communication may be, for example, by display on the client device 150 or by translating the information to an audio message that may be played. Those skilled in the art having the benefit of this disclosure may appreciate still other variations.

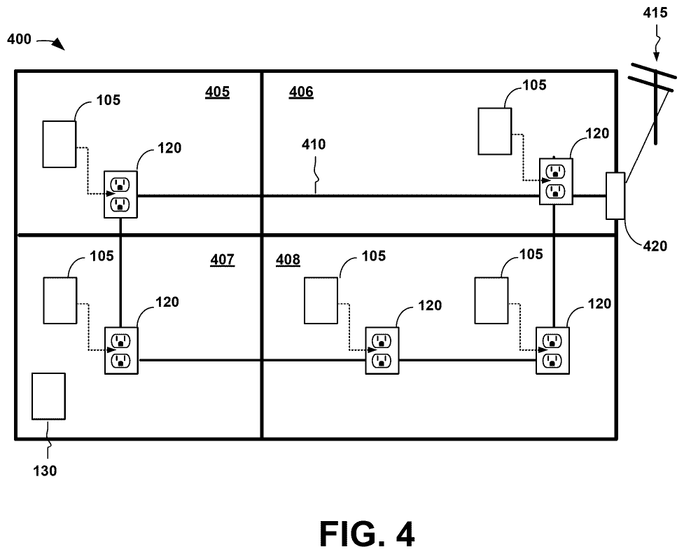

Returning to FIG. 1, the detector 105 is disposed within the structure 110 and is plugged into the electrical socket 120 to detect a predetermined hazard. FIG. 3A-FIG. 3C illustrate one particular implementation of the detector 105 first shown in FIG. 1. FIG. 3A-FIG. 3B are front and back plan views, respectively, of the detector 105. The terms “front” and “back” are defined relative to the socket 120 into which the detector 105 is plugged in use. FIG. 3C schematically depicts the functional components of the detector 105.

Referring collectively to FIG. 1 and FIG. 3A-FIG. 3B, as mentioned above, the plate 145 typically covering the socket 120, both shown in FIG. 1, may be removed. The detector 105 includes one or more male electrical connector(s) 300 by which the detector 105 may be plugged into the socket 120. Note that the male electrical connectors 300 includes, in this particular embodiment, a ground contact.

The detector 105 may be secured to the socket 120 by a fastener 305. The fastener 305 may extend through a bore (not otherwise show) through the body 307 of the detector 105 and threadably affixed to the socket 120 using the same threaded bore by which the plate 145 was previously secured to the socket 120. This particular implementation also includes an optional status indicator 310 indicating whether the detector 105 is receiving power and is otherwise operational.

FIG. 3C schematically depicts one implementation of the detector 105. The detector 105 includes an electrical detection circuit 315 and a wireless transmitter 320. Both the electrical detection circuit 315 and the wireless transmitter 320 receive electrical power through the male electrical r 300. The electrical detection circuit 315 detects a predetermined hazard and upon detection of the predetermined hazard, generates an electrical signal indicating that the predetermined hazard has been detected. The predetermined hazard may be a gaseous hazard, a thermal hazard, or both a gaseous hazard and a thermal hazard. The wireless transmitter 320, upon receiving the electrical signal, transmits a wireless signal indicating that the predetermined hazard has been detected.

Returning again to FIG. 1, the detector 105 is plugged into an electrical socket 120 in an electrical circuit 115 in a structure 110. The detector 105 then senses its environment for a predetermined hazard. Upon the detector 105 detecting the predetermined hazard, detector 105 generates and transmits a wireless signal 155 indicating that the predetermined hazard has been detected. In the illustrated embodiment, the wireless signal 155 is transmitted at 2.4 GHz and may be transmitted in accordance with one or more one of the family of IEEE 802.11 standards or a standard based on the family of IEEE 802.11 standards. One such standard based on the family of IEEE 802.11 standards is WIFI®.

The monitoring unit 130, meantime, is wirelessly monitoring a location of the structure 100. In particular, the monitoring unit 130 is monitoring those locations within the portions of the structure 100 within its operating range. The monitoring unit 130 detects the wireless signal 155 indicating that the predetermined hazard has been detected. The monitoring unit 130 then transmits a warning signal 160 to the client device 150.

In the embodiment of FIG. 1, the client device 150 is a smart phone. However, the client device may be almost any kind of computing apparatus capable of communicating with the monitoring unit 130. For example, the client device 150 may be, without limitation, a netbook, a tablet, or a laptop. The warning signal 160 is shown to be wireless and, since the client device 150 is a smart phone, may be a wireless telephony signal. However, in alternative embodiments, the warning signal 160 may be transmitted using WIFI® or some other wireless communication protocol. In still other embodiments, the warning signal 160 may be transmitted over a wired connection such as a public or private network (not shown) or in a combination of wireless and wired techniques.

The embodiment of FIG. 1 also shows only a single socket 120 into which a single detector 105 is plugged. However, more typical embodiments will include more than one detector 105, each detector plugged into a respective socket 120. As mentioned above, it is generally recommended to have at least one detector 105 in each room or area of a building or structure. It may also be desirable to have more than one detector 105 in a given room or area if the room or area is relatively large.

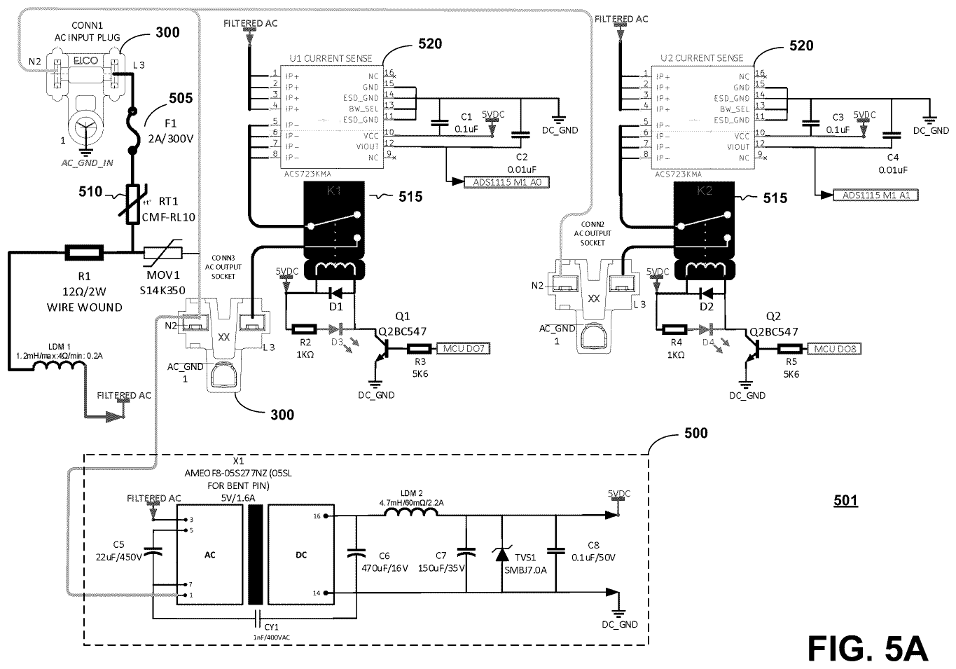

FIG. 4 illustrates another typical embodiment. The interior of the structure 400 is shown divided into four areas or rooms 405-408. Each of the rooms 405-408 includes at least one socket 120 into which a respective detector 105 is plugged as indicated by the dashed arrows. Many local building codes require one electrical socket per wall in a habitable structure, providing an opportunity to deploy two detectors 105 in a single room or area as is shown for room 408. The electrical circuit 410 of which the sockets 120 are a part receives AC power from the grid 415 through a braker panel 420.

Each of the detectors 105 is in wireless communication with the monitoring unit 130 as described above. In this particular embodiment, the wireless signals 155 generated and transmitted by the detectors 105 includes a hazard identifier identifying the detected predetermined hazard and a location identifier identifying the location of the detector. The monitoring unit 130 may then, in some embodiments, display the location and/or hazard type to the user and/or include this information in the warning signal 160 for display on the client device 150. The location identifiers may be hardwired into the detectors 105, programmed into the detectors 105, or assigned during a discovery process on initialization and/or setup.

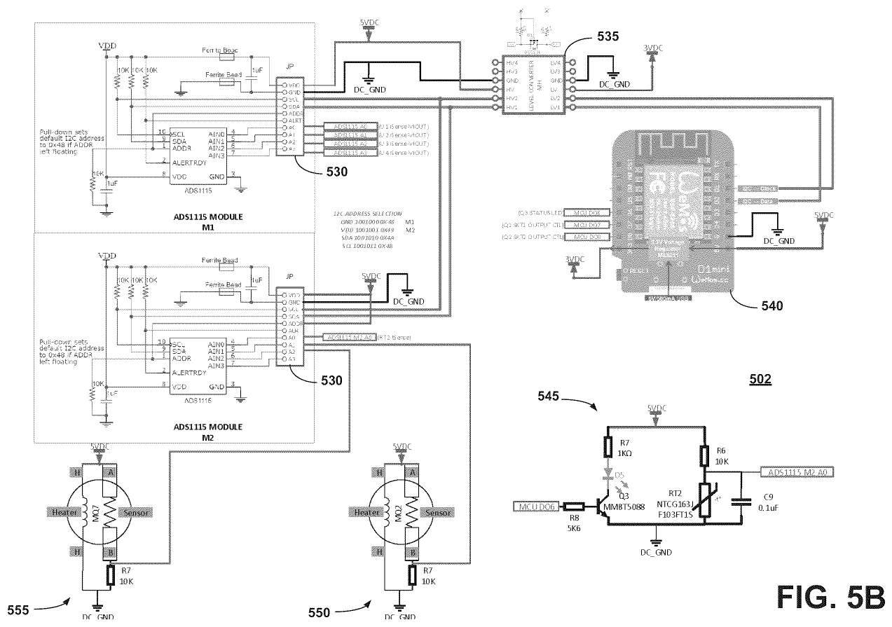

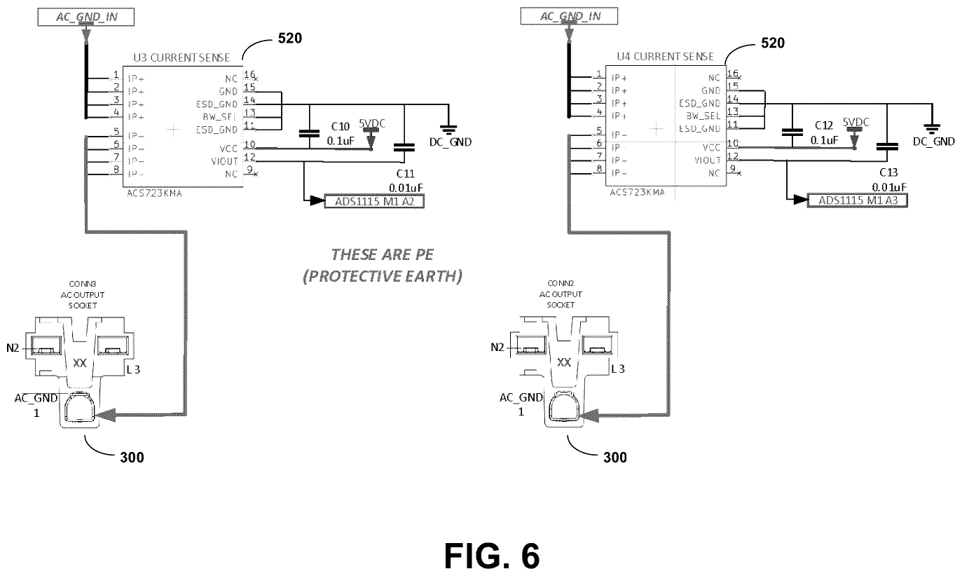

FIG. 5A-FIG. 5B and FIG. 6 illustrate one particular implementation of the electrical detection circuit 315, shown in FIG. 3, of the detector 105 first shown in FIG. 1. FIG. 6 is, more particularly, a detail of selected portions of FIG. 5A. The electronics are powered by DC power derived from the 120 V line voltage received via the male electrical connectors 300 before being converted and conditioned by the AC/DC converter circuit 500, shown in FIG. 5A. The portion 501 of the electrical detection circuit 315 shown in FIG. 5A also includes a thermal fuse 505, a thermistor sensor 510, a pair relays 515 (one for each male electrical connector 300), and a pair of current sensors 520 (also one for each male electrical connector 300).

Turning now to FIG. 5B, the portion 502 of the electrical detection circuit 315 shown therein includes a pair of connectors 530 (also one for each male electrical connector 300), a signal conditioner 535, a processor 540, a voltage regulator 545, a carbon dioxide detector 550, and a smoke detector 555. The signals MCU DO7 and MCU D08 from the portion 501 shown in FIG. 5A enter the portion 502 shown in FIG. 5B via the pins A1 of the connectors 530.

As shown in FIG. 5A, a thermal fuse 505 is used to disconnect from the hot line and the thermistor sensors to monitor and report overheated wires of that location. Showing the thermal fuse in diagram 1A and the thermal fuse when a problem arises and your location has become a danger, then the thermistor tells the processor that “things are too hot”. Then the processor tells the thermal fuse and the disconnect is done from the hot line. Carbon Dioxide poison, thermal fuse, and detecting smoke, all bring harm to humans being. FIG. 5B reflects the processor 540, a microprocessor, with an external device and gives the module WIFI® capability. The processor 540 also gives a signal when carbon dioxide or a smoke signal has been raised and the alarm status reports an electrical fire is in progress. The living room area has become a danger zone, smoke has been detected in the garage, and carbon dioxide poison is detected in Bedroom number

4. In the illustrated embodiment, also included is the customer's account number for an offsite monitoring subscription.

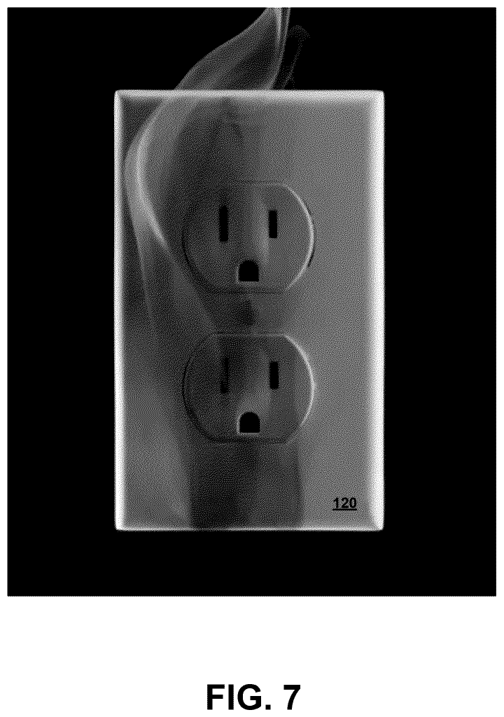

FIG. 7 depicts a predetermined hazard such as may be detected using the method and apparatus disclosed herein. In particular, a socket 120 is shown emitting smoke, a gaseous hazard. Other gaseous hazards such as carbon dioxide, carbon monoxide, and or fumes off-gassed by burning plastics may also be present but not visible to the naked eye. These and other gaseous hazards may be detected using appropriate detectors such as, for example, the carbon dioxide detector 550 and the smoke detector 555 shown in FIG. 5B. The smoke may also result from the thermal hazard in which the wiring or electrical connections (not shown) of the socket 120 overheat. These and other predetermined hazards may be detected and warnings provided as described herein.

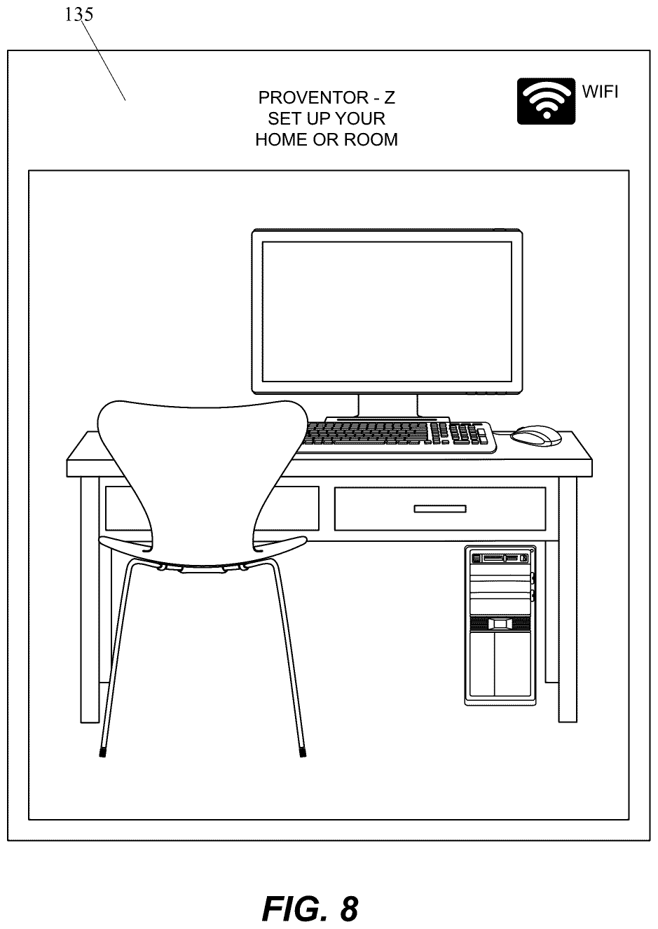

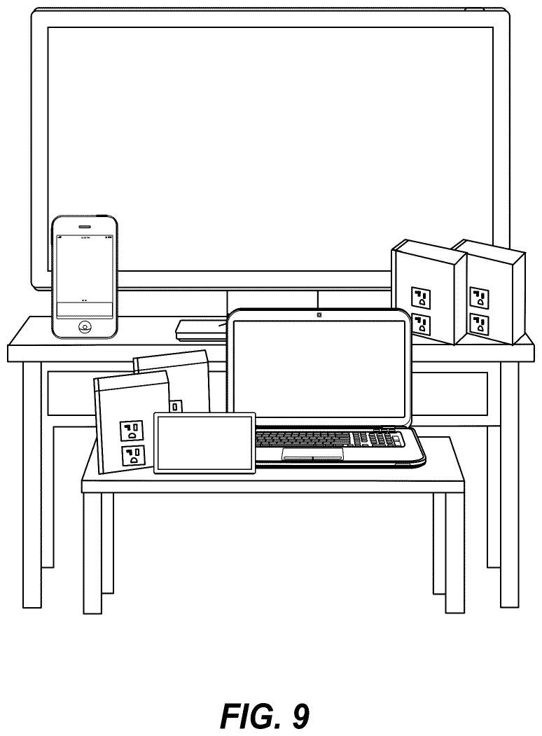

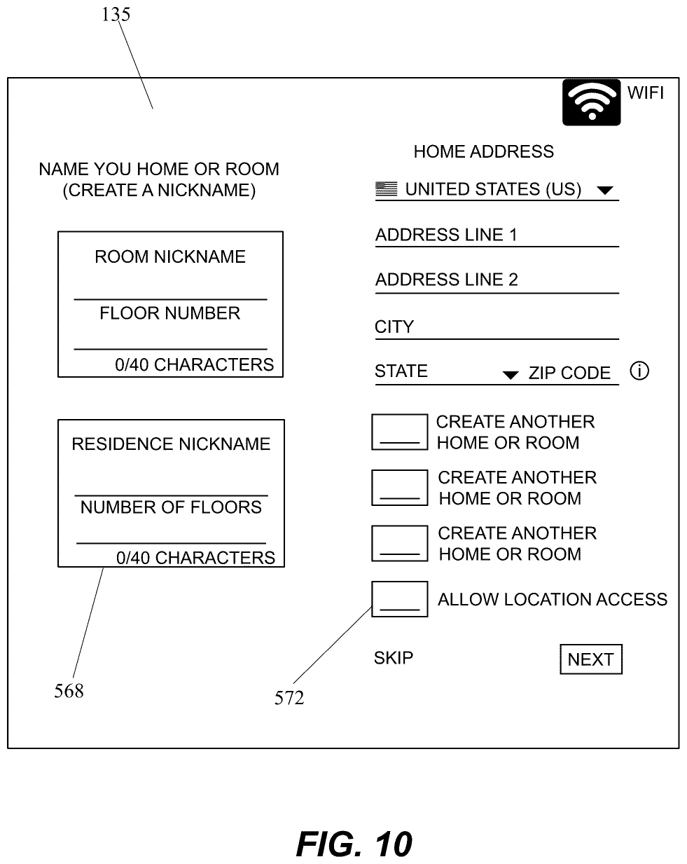

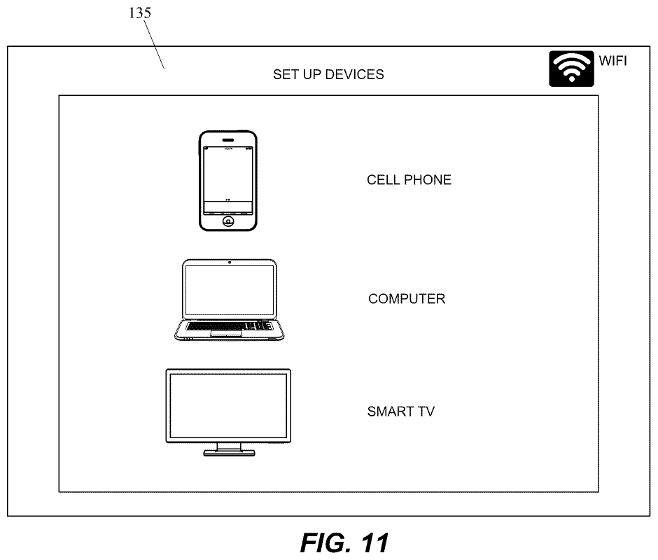

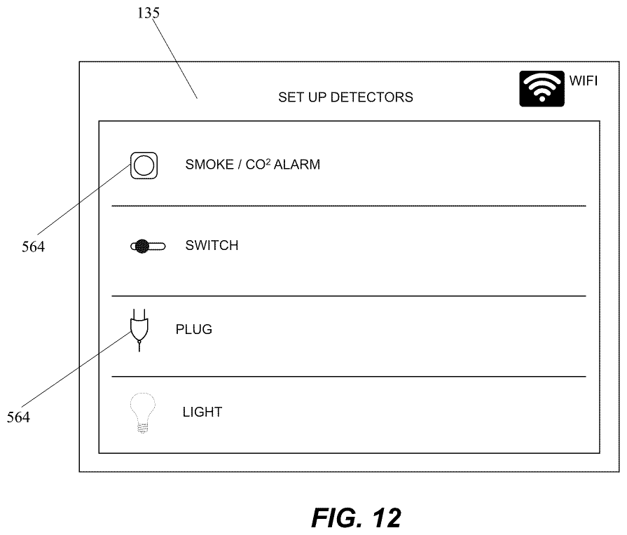

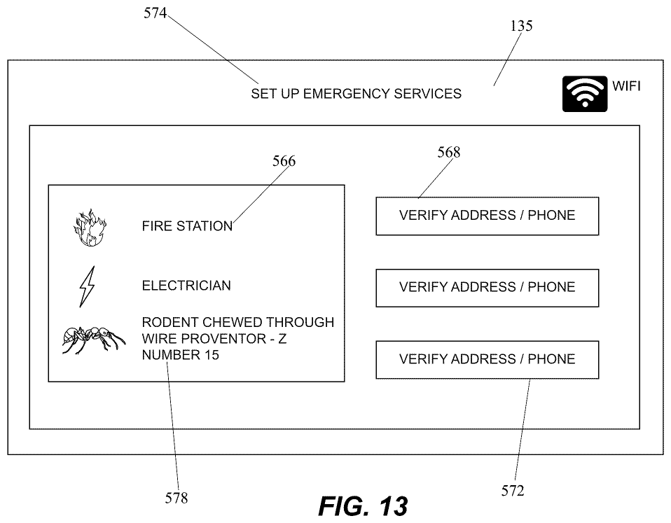

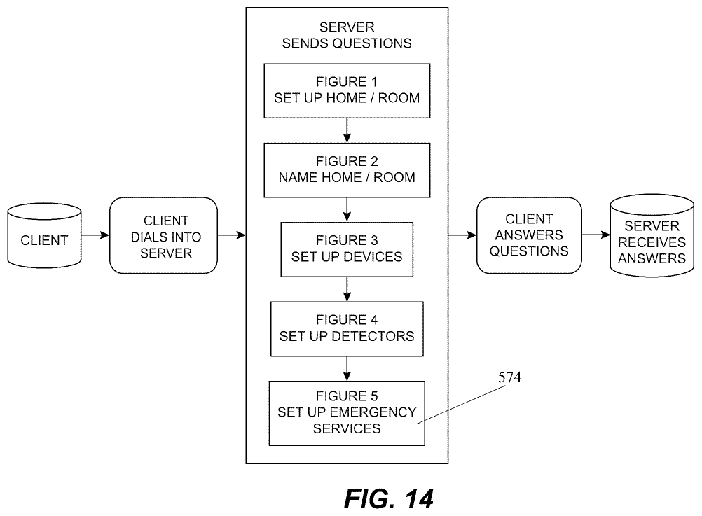

Referring now to FIGS. 8-14, the system according to another embodiment of the present disclosure includes a hazard detection and notification system comprising a plurality of detectors for detecting a plurality of predetermined hazards. As previously mentioned, the predetermined hazard may be a gaseous hazard, a thermal hazard, or both a gaseous hazard and a thermal hazard. A socket 120 emitting smoke and other gaseous hazards such as carbon dioxide, carbon monoxide, and or fumes off-gassed by burning plastics may also be present but not visible to the naked eye. In the instance of an overheated socket, the smoke is indicated as a thermal hazard in which the wiring or electrical connections of the socket 120 overheat. As previously discussed, these and other predetermined hazards may be detected and warnings provided as described herein.

Each detector 105 is configured to produce an electrical signal upon detection of at least one of the predetermined hazards. A central processing unit 131 receives the electrical signals from the detectors and a wireless transmission module transmits real-time hazard notifications 564 wirelessly to a central processing unit upon detection of at least of the plurality of the predetermined hazards. As previously mentioned, exemplary real-time hazard notifications 564 can include any of the predetermined hazard including a gaseous hazard, a thermal hazard, or both a gaseous hazard and a thermal hazard or pest damage to component parts in the system.

A database is provided within the central processing unit 131 and wherein the database contains emergency response location data 566 based on the detection of the plurality of predetermined hazards transmitted by the detectors, user data 568, spatial data 572, and visual indicators of the location of the detected hazard. As provided above, exemplary response location data 566 can include notifications that the living room area has become a danger zone, smoke has been detected in the garage, and carbon dioxide poison is detected in a specific bedroom. User data 568 and spatial data 572 can include the location of the user, floor number, and account number for a monitoring subscription. Visual indicators of the location of the detected hazard can include a display of specific outlets that have overheated to the point of distress and providing visual indicators of their locations. The central processing unit 131 is further configured to initiate an automated emergency response 574 based on the detection of the at least one of the plurality of predetermined hazards. The user interface display unit 135 would allow users to interact with the central processing unit 131 to acknowledge notifications, request assistance, or initiate emergency protocols. Exemplary automated emergency responses 574 as provided herein can include the automated emergency dispatch of a fire department, electrician, or pest control. The user can acknowledge notifications of an emergency dispatch by interacting with the interface display unit 135 to acknowledge notifications, further request assistance, or initiate additional emergency protocols.

A user interface display unit 135 is in communication with the central processing unit 131 and wherein the user interface display unit 135 displays the user data 568 and is further configured for a user to manually select an emergency response location based on the detected plurality of predetermined hazards. These locations as required herein can include local fire stations, pest control services, or public facilities providing electrical services. The user interface display unit 135 establishes seamless communication with the central processing unit to enable efficient data transfer, real-time processing, and synchronized user interactions, enhancing the overall user experience and unit functionality. The user interface display unit 135 is thereby capable of providing interactive messages 578, hazard locations, notifications, and real-time status updates to users.

The user interface display unit 135 displays detailed information about the location, floor number, and account number of users affected by the detected hazards. The user interface display unit 135 can thereby identify specific outlets that has overheated to the point of distress and provides visual indicators of their locations and wherein the user interface display unit 135 further allows users to interact with the unit to acknowledge notifications, request assistance, or initiate emergency protocols.

The foregoing outlines the features of several embodiments so that those of ordinary skill in the art may better understand various aspects of the present disclosure. Those of ordinary skill in the art should appreciate that they may readily use the present disclosure as a basis for designing or modifying other processes and structures for carrying out the same purposes and/or achieving the same advantages of various embodiments introduced herein. Those of ordinary skill in the art should also realize that such equivalent constructions do not depart from the spirit and scope of the present disclosure, and that they may make various changes, substitutions, and alterations herein without departing from the spirit and scope of the present disclosure.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

It will be appreciated that layers, features, elements, etc., depicted herein are illustrated with particular dimensions relative to one another, such as structural dimensions or orientations, for example, for purposes of simplicity and ease of understanding and that actual dimensions of the same differ substantially from that illustrated herein, in some embodiments. Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application and the appended claims are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

This concludes the detailed description. The particular examples disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular examples disclosed above may be altered or modified and all such variations are considered within the scope and spirit of the invention. Accordingly, the protection sought herein is as set forth in the claims below.

What is claimed is:

1. A hazard detection and notification system comprising:
a plurality of detectors for detecting predetermined hazards;
each detector configured to produce an electrical signal upon detection of a predetermined hazard;
a central processing unit for receiving electrical signals from the detectors;
a wireless transmission module for transmitting real-time hazard notifications wirelessly to the central processing unit upon detection of a predetermined hazard; and
a database within the central processing unit containing emergency response location data, user data, and spatial data.

2. The system of claim 1 further comprising:
a user interface display unit in communication with the central processing unit;
the user interface display unit displaying emergency response locations, user data, visual indicators of hazards, voice indicators of hazards, and user locations in relation to the predetermined hazards; and
the user interface enabling user interaction and manual selection of emergency response locations.

3. The system of claim 1 further comprising:
an automated response mechanism within the central processing unit;
the central processing unit identifying the nearest emergency response location from the database;
initiating automated emergency response based on detected hazards, unless overridden by user intervention.

4. A method for hazard detection and notification comprising:
detecting predetermined hazards using a plurality of detectors;
producing electrical signals upon detection of hazards by the detectors;
transmitting real-time hazard notifications wirelessly to a central processing unit;
storing emergency response location data, user data, and spatial data in a database within the central processing unit.

5. The method of claim 4 further comprising:
displaying emergency response locations, user data, visual indicators of hazards, voice indicators of hazards, and user locations on a user interface display unit in communication with the central processing unit;
enabling user interaction and manual selection of emergency response locations through the user interface display unit.

6. The method of claim 4 further comprising:
utilizing an automated response mechanism within the central processing unit;
identifying the nearest emergency response location from the database; and
initiating automated emergency response based on detected hazards, unless overridden by user intervention.
